(19) United States
(12) Patent Application Publication
(10) Pub. No.: US 2026/0281684 A1
(43) Pub. Date: Sep. 17, 2026

(54) SYSTEM AND METHOD FOR EMERGENCY SERVICE SELECTION BASED ON REGIONAL IDENTITY

(71) Applicant: Cisco Technology, Inc., San Jose, CA (US)

(72) Inventors: Mark Grayson, Maidenhead (GB); Srinath Gundavelli, San Jose, CA (US)

(21) Appl. No.: 19/268,456

(22) Filed: Jul. 14, 2025

Related U.S. Application Data
(60) Provisional application No. 63/771,978, filed on Mar. 14, 2025.

(51) Int. Cl. H04W 4/90; H04W 48/16

(52) U.S. Cl. CPC H04W 4/90; H04W 48/16

(57) ABSTRACT

Techniques herein provide for the ability to encode regulatory, country, or region information in network identifiers to enable support of emergency calling systems that enable per regime authorization and permissions. In at least one embodiment, a method includes obtaining an emergency calling network identifier by a wireless device, wherein the emergency calling network identifier includes a first sub-identifier that identifies an emergency calling service and includes a second sub-identifier that identifies a region in which the emergency calling network identifier is to be utilized for emergency calling; upon triggering an emergency call for the wireless device, matching the emergency calling network identifier to a network identifier obtained by the wireless device from a wireless network; and initiating the emergency call for the wireless device with the wireless network from which the network identifier was obtained.

### PRIORITY CLAIM

This application claims the benefit of priority under 35 U.S.C. § 119 to U.S. Provisional Application No. 63/771,978, filed Mar. 14, 2025, the entirety of which is incorporated herein by reference.

### TECHNICAL FIELD

The present disclosure relates to wireless networking and communication services.

### BACKGROUND

Networking architectures have grown increasingly complex in communications environments, particularly mobile networking environments. In particular, wireless networks are offered in many locations, such as malls and large public venues. With increased wireless network coverage across many locations, it is important that users can connect to wireless networks and be provided public emergency services via wireless network connections. However, there are significant challenges with providing emergency services in different wireless networks, such as wireless local area networks.

### BRIEF DESCRIPTION OF THE DRAWINGS

FIG. 1 is a block diagram of a system that may be implemented to facilitate emergency service selection based at least on a regional identity, according to an example embodiment.

FIGS. 2A, 2B, and 2C are diagrams illustrating example details for utilizing Roaming Consortium Organization Identifier (RCOIs) as emergency network calling identifiers that can be used to facilitate emergency service selection, according to various example embodiments.

FIG. 3 is a flowchart depicting a method according to an example embodiment.

FIG. 4 is a hardware block diagram of device configured to perform functions associated with operations discussed in connection with embodiments herein.

### DETAILED DESCRIPTION

### Overview

There are various proposals to provide emergency calling support to wireless local area network (WLAN) systems, such as Institute of Electrical and Electronics Engineers (IEEE) 802.11 or Wi-Fi® systems, including augmenting existing technical and legal frameworks to permit the access to emergency calling services by end users and end user devices (e.g., wireless devices) that may not be associated with a cellular subscription. It is likely that the adoption of such a capability will be deployed on a region-by-region basis. A regional based approach to network selection and authorization is therefore beneficial.

Broadly, embodiments herein define techniques that provide for the ability to encode regulatory/country information in network identifiers, referred to herein as “emergency calling network identifiers” to enable support of global and/or regional emergency calling systems that can enable per-regime authorization and permissions for emergency calls initiated by wireless devices.

In at least one embodiment, one or more corresponding WLAN/Wi-Fi profile(s) (also referred to herein as Passpoint profile(s)) associated with corresponding regional emergency calling network identifier(s) can be provisioned in an end user device (broadly, a ‘wireless device’ as referred to herein) that can enable WLAN emergency calling for the wireless device thereby enabling regional profile(s) for the device. In at least one embodiment, the regional profile(s) or, more specifically, the emergency calling network identifier(s) thereof, can be provisioned in WLAN equipment of wireless local access network providers, such as WLAN access points (APs), for service providers that have agreed to provide the emergency calling services for a given region.

In at least one embodiment, one or more wireless wide area network (WWAN) emergency calling network identifier(s) can be provisioned in a wireless device to enable WWA emergency calling for the wireless device. In at least one embodiment, the emergency calling network identifier(s), can be provisioned for WWA radio nodes (e.g., gNodeBs, etc.), for service providers that have agreed to provide the emergency calling services for a given region.

In some aspects, the techniques described herein relate to a method including: obtaining an emergency calling network identifier by a wireless device, wherein the emergency calling network identifier includes a first sub-identifier that identifies an emergency calling service and includes a second sub-identifier that identifies a region in which the emergency calling network identifier is to be utilized for emergency calling; upon triggering an emergency call for the wireless device, matching the emergency calling network identifier to a network identifier obtained by the wireless device from a wireless network; and initiating the emergency call for the wireless device with the wireless network from which the network identifier was obtained.

### Example Embodiments

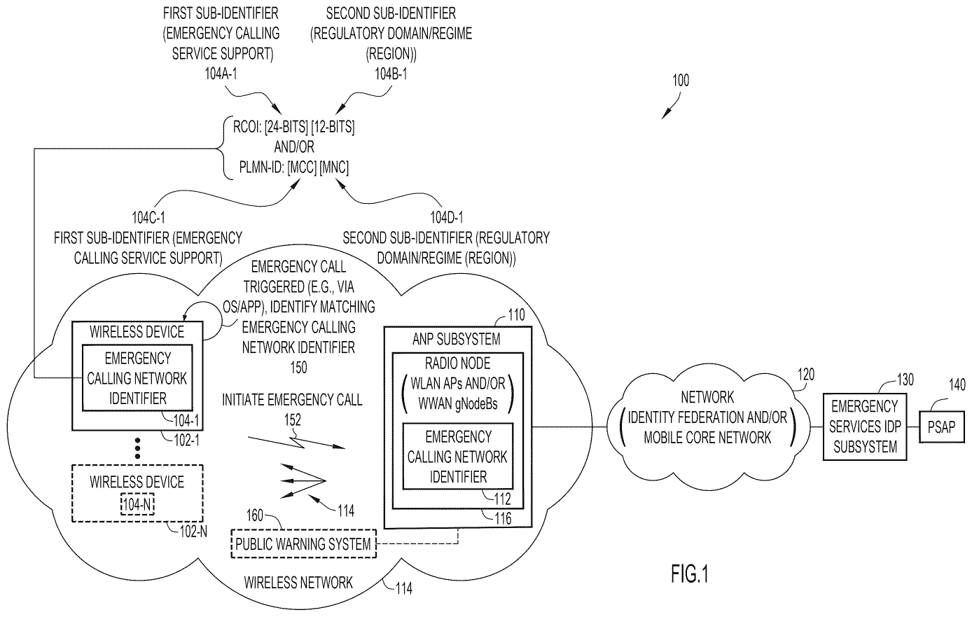

Referring to FIG. 1, FIG. 1 is a block diagram of a system 100 that may be implemented to facilitate emergency service selection based at least on a regional identity, according to an example embodiment. In at least one embodiment, system 100 may include an Access Network Provider (ANP) subsystem, such as an ANP subsystem 110, an emergency services Identity Provider (IDP or IdP) subsystem, such as an emergency services IDP subsystem 130, a network 120, and a public safety answering point (PSAP), such as a PSAP 140. Also shown in FIG. 1 are an ‘N’ number of wireless devices, such as a wireless device 102-1 through a wireless device 102-N.

ANP subsystem 110 includes one or more radio nodes, such as a radio node 112, in which the one or more radio nodes can be implemented as any combination of one or more wireless local area network (WLAN) radio nodes, referred to herein as WLAN access points (APs), and/or one or more wireless wide area network (WWAN) radio nodes, such as one or more gNodeBs. Radio node 112 (e.g., any number of WLAN APs and/or WWAN gNodeBs) can provide a wireless network 114 through which one or more wireless devices can wirelessly connect to the radio node 112 for one or more services, such as emergency services as discussed for embodiments herein. Regarding WLAN connectivity, ANP subsystem 110 can facilitate any IEEE 802.11 standards variant (e.g., Wi-Fi5, Wi-Fi6/6E, Wi-Fi7, etc.) in accordance with embodiments herein.

In at least one embodiment, an ANP, such as ANP subsystem 110, may be considered any entity providing internet connectivity services via a radio access network (RAN), for example, provided via radio node 112/wireless network 114, and an IDP, such as emergency services IDP subsystem 130, may be considered an entity that manages identity credentials and policies for wireless devices via wireless profiles, such as Passpoint profiles, and provides authentications services for such wireless devices. In accordance with embodiments herein, emergency services IDP subsystem 130 can include a Third Generation Partnership Project (3GPP) Internet Protocol (IP) Multimedia Subsystem (IMS) that can include any combination of a Connectivity Location Function (CLF), an Enhanced (or Emergency) Call Session Control Function (E-CSCF), a proxy CSCF (P-CSCF) and/or a Route (or Routing) Determination Function (RDF).

To facilitate emergency calling services (e.g., E911 services) for a system, such as system 100, a PSAP, such as PSAP 140, may be considered a facility at which emergency calls are received under the responsibility of a public or government authority. A CLF can maintain mappings between an endpoint's (wireless device's) dynamically assigned IP address and the endpoint's physical location. Generally, an RDF can provide for resolving a physical location, such as a civic address and/or a geospatial address, to a serving PSAP. A conventional E-CSCF can query a conventional CLF with a public IP address of a Session Initiation Protocol (SIP) user agent (e.g., operating on a wireless device of a user initiating an emergency call) to recover the location of the SIP user agent/wireless device/user. The E-CSCF can then use this location in its PSAP routing logic to determine an appropriate PSAP to which to route an emergency call.

For system 100, ANP subsystem 110 including radio node 112 can interface with emergency services IDP subsystem 130 via network 120. Emergency services IDP subsystem 130 can further interface with PSAP 140. Although one PSAP is shown in FIG. 1, it is to be understood that emergency services IDP subsystem 130 may interface with multiple PSAPs, each serving different areas or regions.

In at least one embodiment, network 120 may be implemented as and/or may include an identity federation subsystem and/or a 3GPP mobile core network. Thus, in some instances, system 100 can be considered a federation-based (or identity federation-based) roaming architecture facilitated via an identity federation (provided via network 120) involving identity federation-enabled signaling endpoints. In one embodiment, an identity federation subsystem as may be provided via network 120 may be implemented as an OpenRoaming (OR) federation entity involving OpenRoaming enabled signaling endpoints. In at least one embodiment, the signaling communication between peers of such a system, such as radio node 112 implemented as a WLAN AP of ANP subsystem 110, and emergency services IDP subsystem 130 can be secured using mutual authentication based on the certificates issued under the Wireless Broadband Alliance (WBA) private PKI (public key infrastructure) operations.

Further, in some instances, network 120, can include 3GPP mobile core network functionality such as an Access and Mobility Management Function (AMF), a Session Management Function (SMF), a Policy Control Function (PCF), one or more User Plane Functions (UPFs), and/or any other 3GPP network functions to facilitate WWAN/cellular connectivity via wireless network 114, such as Fourth Generation/Long Term Evolution (4G/LTE), Fifth Generation (5G), etc. WWAN/cellular connectivity. In at least one embodiment, wireless network 114 can be a private cellular (e.g., 5G) network.

Turning back to a WLAN OpenRoaming environment, the use of Roaming Consortium Organization (sometimes Organizational) Identifiers (RCOIs) for automating WLAN network Selection has been specified by the Wi-Fi Alliance's Passpoint Specification (Passpoint). The OpenRoaming federation makes extensive use of RCOIs in order to define polices that can be supported by particular ANPs and those policies supported by IDPs or IdPs.

An RCOI can be a 3-octetor a 5-octet value that can be carried in an 802.11 beacon information element (IE) and/or can be sent via Access Network Query Protocol (ANQP) messages that can be used to identify the identity provider, or group of identity providers, that are supported by a given network (e.g., a given WLAN). Passpoint is a Wi-Fi Alliance (WFA) protocol through which Passpoint profiles provisioned for wireless devices enable such wireless devices to discover and authenticate to WLAN/Wi-Fi hotspots that provide internet access. A conventional Passpoint profile may include a user's identity and credentials, along with access network identifiers that can enable a user's wireless device to authenticate to an access network.

Supported RCOIs can be provisioned in WLAN equipment by ANPs (WLAN APs) and can be configured in the Passpoint profile of wireless devices managed by corresponding IDPs. During operation of a wireless device (also referred to interchangeably herein as a ‘mobile device’, a ‘wireless client’, a ‘wireless device’, a station (STA), or variations thereof) under conventional OpenRoaming/Passpoint operations, an authentication exchange can be triggered with an IDP via the WLAN equipment operated by an ANP when there is a match of RCOIs between what is being broadcast by given a WLAN of an ANP and a Passpoint profile configured for the wireless device. General RCOI structure and semantics used in OpenRoaming are prescribed at least by “WBA OpenRoaming Wireless Federation draft-tomas-openroaming-05,” published Apr. 15, 2025.

In accordance with embodiments herein, techniques are provided for defining an identifier, referred to herein as an ‘emergency calling network identifier’ that can be used to enable emergency calling services for wireless devices in a WLAN and/or WWAN.

In accordance with embodiments herein, a given emergency calling network identifier can be configured in a wireless device, referred to herein as a ‘device-identifier’, and can be configured in one or more radio nodes of an access network (wireless network), referred to herein as an ‘access-identifier’. During operation, the wireless device can use standard matching techniques to trigger an authentication when the access-identifier, which can be included in a wireless broadcast of an WLAN AP or WWAN gNodeB, returned in a query response (e.g., via an Access Network Query Protocol (ANQP) exchange) for a WLAN AP, or the like, matches the device-identifier configured in the wireless device.

In at least one embodiment, an emergency calling network identifier can be sub-divided into two sub-identifiers—a first sub-identifier and a second sub-identifier. In at least one embodiment, the first sub-identifier can be used as an identifier to indicate, by a given ANP subsystem, that the ANP subsystem supports emergency calling service.

In at least one embodiment, the second sub-identifier can be used to encode a regulatory regime, broadly referred to herein as a region or a plurality of regions, that is responsible for the wireless device provisioned with the device-identifier and/or the wireless access network (e.g., AP) configured with the access-identifier (e.g., responsible for, in that the regulatory regime, authority, or jurisdiction that specifies rules or guidelines that are to be applied by/for entities, devices, and/or elements providing/accessing emergency services). Stated differently, the second sub-identifier can be used to identify a region or multiple regions in which the emergency calling network identifier can be utilized for emergency calling. Thus, the second sub-identifier can be used to encode the region/regulatory domain in which a wireless device and/or the AP is expected to operate.

As illustrated in FIG. 1, wireless device 102-1 can be configured with at least one emergency calling network identifier, such as an emergency calling network identifier 104-1 (device-identifier) and ANP subsystem 110, including radio node 112, can be configured with the same at least one emergency calling network identifier, shown in FIG. 1 as an emergency calling network identifier 116 (access-identifier). An emergency calling network identifier can be configured for any number of wireless devices (device-identifiers); for example, wireless device 102-N can also be configured with an emergency calling network identifier 104-N.

In at least one embodiment, the emergency calling network identifier 104-1 can be obtained by wireless device 102-1 via a broadcast from a public warning system 160, as illustrated in FIG. 1. For example, when the wireless device 102-1 is within a given region that is to utilize a particular emergency calling network identifier, one or more public warning system broadcasts can be provided (e.g., via public warning system 160 and radio node 112) indicating the emergency calling network identifier that is to be configured for/used by the wireless device for initiating an emergency call such that the wireless device 102-1 can store the particular emergency calling network identifier (or identifiers, if applicable).

In at least one embodiment, the emergency calling network identifier 104-1 can be obtained by the wireless device 102-1 via at least one of a network service provider and/or an equipment manufacturer or vendor of the wireless device. For example, in at least one embodiment, the emergency service calling network identifier 104-1 can be provisioned for the wireless device 102-1 when the wireless device 102-1 is onboarded for operation via a given network service provider in which the emergency service calling network identifier 104-1 can be configured via a Passpoint profile provided for the wireless device 102-1, via an electronic or embedded Subscriber Identity Module (eSIM) profile provided for the wireless device 102-1, and/or the like. In another embodiment, in at least one embodiment, wireless device 102-1 can be configured with the emergency calling network identifier 104-1 during manufacturing of the wireless device 102-1 (e.g., manufactured within a given region) and/or through the wireless device 102-1 being acquired by a given vendor (e.g., operating within a given region).

In at least one embodiment for a WLAN/OpenRoaming implementation, the emergency calling network identifier 104-1 (device-identifier) configured for wireless device 102-1 can be configured as a 5-octet RCOI including a first sub-identifier (shown in FIG. 1 as 104A-1) including 24-bits (encoded in octets 1, 2, and 3 of the RCOI) that can be used to encode the indication of the emergency calling service being supported by ANP subsystem 110/radio node 112. The RCOI can include a second sub-identifier (shown in FIG. 1 as 104B-1) including 12-bits (encoded in octets 4 and 5 of the RCOI) of the 16 bits available for octets 4 and 5 in which the second sub-identifier can be used to encode an indication identifying the regulatory regime or region in which the emergency calling network identifier can be utilized for emergency calling. The remaining 4-bits of the RCOI (4-bits of octet 5) can be set to zero or some other predefined 4-bit setting in at least one embodiment based on system and/or deployment configurations/environments.

The same RCOI as configured for the wireless device 102-1 (and any other wireless devices) can also be configured as the emergency calling network identifier 116 (access-identifier) for the radio node 112 of the ANP subsystem 110 in accordance with embodiments herein. During operation, the ANP subsystem 110 via radio node 112 (e.g., a WLAN AP) at which the emergency calling network identifier 116 is configured, can transmit or otherwise provide the emergency calling network identifier 116 to wireless device 102-1, as generally shown at 114. In various embodiments, the emergency calling network identifier 116 can be broadcast by radio node 112 (e.g., via WLAN beacons), provided via an ANQP exchange, or the like in order for the wireless device 102-1 to obtain the emergency calling network identifier 116 configured for ANP subsystem 110/radio node 112.

In at least one embodiment, the 24-bits of the first sub-identifier 104A-1 for the RCOI (via octets 1/2/3) may be encoded as “D1-6C-B4”. As noted herein, the first sub-identifier can be used to encode the indication of the emergency calling service being supported by ANP subsystem 110/radio node 112 such that the first sub-identifier has a global scope and reserved namespace to indicate support for the emergency calling service. It is noted that the first sub-identifier value of “D1-6C-B4” is provided for illustrative purposes and is not meant to limit the broad scope of embodiments herein; any value can be encoded for the first sub-identifier to indicate an emergency calling service being supported by a given ANP subsystem/radio node in accordance with embodiments herein. In at least one embodiment, the 12-bits of the second sub-identifier 104B-1 for the RCOI (via octets 4/5) may be encoded as an International Organization for Standardization (ISO) 3166 numeric value for a given country (e.g., region), for example, a numeric value between 0-999, represented in hexadecimal format.

As an example, emergency calling services corresponding to the United States of America (USA) regulatory regime (corresponding to ISO3166 country code 840 (integer 840) or “34-8X” for hexadecimal “348” where ‘X’ corresponds to the remaining 4-bits of octet 5 set to zero or some other predetermined bit setting) may have a corresponding RCOI (emergency calling network identifier) of “D1-6C-B4-34-80.” In another example, emergency calling services corresponding to the United Kingdom (UK) regulatory regime (corresponding to ISO3166 country code 826 (integer 826) or “33-AX” for hexadecimal “33A” where ‘X’ corresponds to the remaining 4-bits of octet 5 set to zero or some other predetermined bit setting) may have a corresponding RCOI (emergency calling network identifier) of “D1-6C-B4-33-A0”

In at least one embodiment, the emergency calling network identifier 104-1 configured for wireless device 102-1 can be configured for an emergency services wireless profile, such as an emergency services Passpoint profile, which can be configured for the wireless device. The emergency services wireless profile may be configured to include the emergency calling network identifier 104-1 configured as an RCOI including the first sub-identifier 104A-1 (24-bits) and the second sub-identifier 104B-1 (12-bits) in accordance with embodiments herein. The emergency services wireless profile may also be configured to include a non-user-specific or common authentication identity, specifically, an identity that is common to or the same for all wireless devices being configured with the emergency services profile, such as “anonymous@sos.emergencysvc.org,” “anonymous@sos.fcc.org,” or any appropriate (commonname@realm) non-user-specific/common identity. Additionally, the emergency services wireless profile may be configured to include at least one common authentication credential (i.e., common authentication credential(s), such as a common password, a common certificate, etc. that is/are common to or the same/shared among all wireless devices being configured with the emergency services wireless profile), that can be utilized to initiate an emergency call.

In some instances, the term ‘credentials’ can be used to collectively refer to an authentication identity and authentication credentials for a wireless profile. Generally, credentials in authentication context allow an endpoint to present a user's identity and some secret element that a device shares with the network (e.g., a password, certificates, etc.). However, in accordance with embodiments herein, shared credentials, which broadly in some instance can include a common identity and common credentials (e.g., username: Emergency-Caller; Password: e911), do not identify a specific user, as they are common (non-user-specific) credentials. Common credentials can be configured for wireless devices utilizing various techniques.

In at least one embodiment for a WWAN implementation, the emergency calling network identifier 104-1 (device-identifier) configured for wireless device 102-1 can be configured as a Public Land Mobile Network Identifier (PLMN-ID) including a first sub-identifier (shown in FIG. 1 as 104C-1) including a Mobile Country Code (MCC) that can be used to encode the indication of the emergency calling service being supported by ANP subsystem 110/radio node 112. The PLMN-ID can include a second sub-identifier (shown in FIG. 1 as 104D-1) including a Mobile Network Code (MNC) that can be used to encode an indication identifying the regulatory regime or region in which the emergency calling network identifier can be utilized for emergency calling.

In at least one embodiment, the first sub-identifier 104C-1 of the PLMN-ID can be encoded as an E212 MCC, as allocated by ITU-SG2 (International Telecommunication Union—Study Group 2). For example, in one instance, the MCC (first sub-identifier 104C-1) can be set to “903”. The 901 country codes are currently defined by ITU-SG 2 to be used in a country agnostic manner and proposals have been made to define the use of 90X country codes for international services (e.g., “903” for indicating an emergency calling service).

In at least one embodiment, the second sub-identifier 104D-1 (MNC) of the PLMN-ID may be encoded as the ISO 3166 numeric value for a given country (e.g., region), for example, a numeric value between 0-999. As an example, emergency calling services corresponding to the USA regulatory regime (country integer 840) may have a corresponding PLMN-ID (emergency calling network identifier) of “903-840” and emergency calling services corresponding to the UK (country code 826) may have a corresponding PLMN-ID (emergency calling network identifier) of “903-826”.

In at least one embodiment, a private WWAN/cellular network can be configured with a PLMN-ID (emergency calling network identifier), for example 902-840, and a private cellular device, such as wireless device 102-1, may be similarly configured with a SIM card elementary field that includes the same PLMN-ID in order to trigger an authentication exchange between the private cellular device and the private cellular network for an emergency call.

In various embodiments, a wireless device, such as wireless device 102-1, can be configured with any combination of RCOI(s) and/or PLMN-ID(s) in order to utilize any emergency calling services for WLANs and/or WWANs.

In various embodiments, a wireless device that is configured to support emergency calling can be configured to support only access networks in one regime (region), can be configured to support access networks in a plurality of regimes (a plurality of regions), and/or can be configured to support access networks in any regime/all regimes, referred to herein as a ‘global regime’ or ‘global region’ that includes all regimes/regions that support emergency calling. In some embodiments, if multiple emergency calling network identifiers are provided for a wireless device, the order of the emergency calling network identifiers may indicate a preference for utilizing one access network (ANP) over another access network for emergency calling. In some embodiments, if multiple emergency calling network identifiers are provided for an ANP subsystem/radio node thereof, the order of the emergency calling network identifiers may indicate a preference for its home regime.

During operation of system 100, as generally shown in FIG. 1 at 150, upon triggering an emergency call for the wireless device 102-1, the wireless device 102-1 can use standard matching techniques to select and initiate an authentication/emergency call with ANP subsystem 110/radio node 112, as generally shown at 152, based on determining that the emergency calling network identifier 104-1 (device-identifier) configured for wireless device 102-1 matches the emergency calling network identifier 116 (access-identifier) obtained from radio node 112 (e.g., via a broadcast, via an ANQP exchange, etc.). In various embodiments, an emergency call can be triggered for a given wireless device, such as wireless device 102-1, based on an emergency calling application (app) configured for the device (e.g., a user of the wireless device can interact with the app to trigger an emergency call), based on an operating system (OS)-based emergency calling function configured for the device (e.g., a user of the wireless device can interact with the app to trigger an emergency call), and/or the like.

The emergency call can be completed via communications/operations involving network 120, emergency services IDP subsystem 130, and PSAP 140, for example, using IMS/SIP communications/operations as would be understood by persons of skill in the art.

Compared with the OpenRoaming use of identities, embodiments herein may facilitate embedding regulatory domain information into a worldwide network identity and/or may facilitate use of an identity matching approach to determine whether an access network accepts emergency calling originated from devices issued with identities provisioned by a foreign regulatory domain.

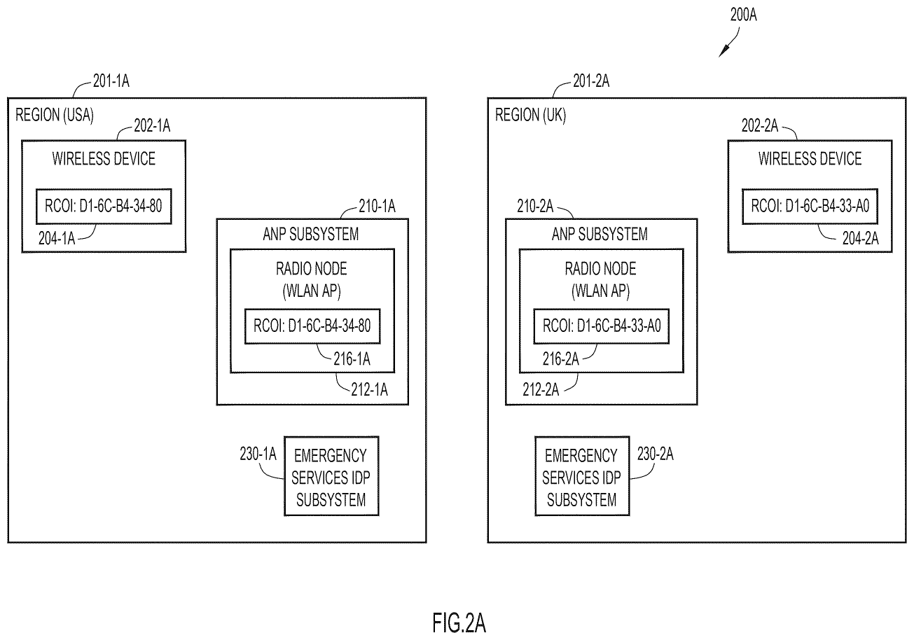

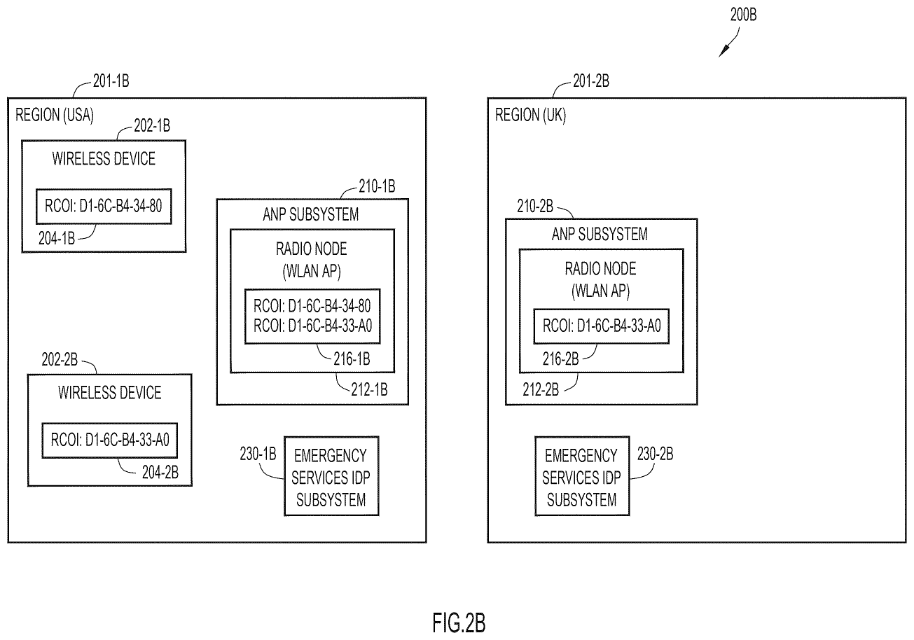

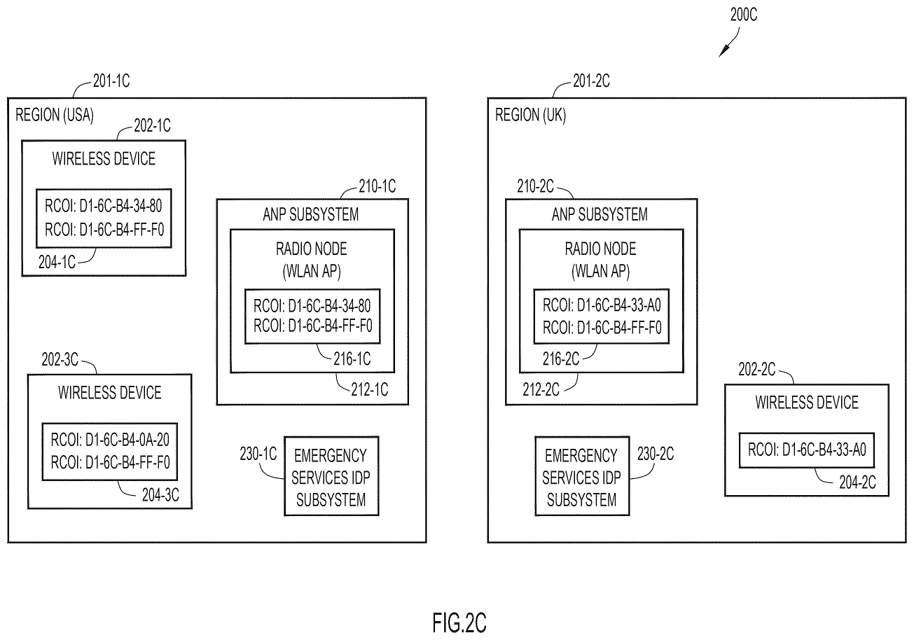

FIGS. 2A, 2B, and 2C are diagrams illustrating example details for utilizing RCOIs as emergency network calling identifiers that can be used to facilitate emergency service selection, according to various example embodiments.

FIG. 2A includes a system 200A illustrating an example in which emergency services IDP subsystems can be deployed in isolation across two different regions but may be configured with RCOIs having a common core identifier; specifically, a common first sub-identifier value and different second sub-identifier values such that emergency services can be appropriately selected by wireless devices within each region.

As shown in FIG. 2A, a region 201-1A may include the USA and a region 201-2A may include the UK. Region 201-1A can include an ANP subsystem 210-1A including a radio node 212-1A (a WLAN AP) and an emergency services IDP subsystem 230-1A. A wireless device 202-1A is also shown within region 201-1A. Region 201-2A can include an ANP subsystem 210-2A including a radio node 212-2A (a WLAN AP) and an emergency services IDP subsystem 230-2A. A wireless device 202-2A is also shown within region 201-2A.

For the example of FIG. 2A, corresponding wireless devices 202-1A and 202-2A can be configured with corresponding emergency calling network identifiers to support access in one regime/region and corresponding ANP subsystems 210-1A and 210-1B can be configured with corresponding emergency calling network identifiers to support access in one regime/region.

As an example, the emergency calling network identifier corresponding to the USA regulatory regime (country integer 840) for region 201-1A may have a corresponding RCOI of “D1-6C-B4-34-80” and the emergency calling network identifier corresponding to the UK (country code 826) for region 201-2A may have a corresponding RCOI of “D1-6C-B4-33-A0.” Thus, the regimes can share a common core identifier (first sub-identifier) of “D1-6C-B4” with the second sub-identifier indicating the specific region in which emergency calling services are provided.

As illustrated in FIG. 2A, wireless device 202-1A can be configured with the RCOI “D1-6C-B4-34-80” for its emergency calling network identifier 204-1A and radio node 212-1A can be configured with the RCOI “D1-6C-B4-34-80” for its emergency calling network identifier 216-1A to provide emergency calling services within region 201-1A. Similarly, wireless device 202-2A can be configured with the RCOI “D1-6C-B4-33-A0” for its emergency calling network identifier 204-2A and radio node 212-2A can be configured with the RCOI “D1-6C-B4-33-A0” for its emergency calling network identifier 216-2A to provide emergency calling services within region 201-2A.

Moving to FIG. 2B, FIG. 2B includes a system 200B illustrating an example in which regional emergency services IDP subsystems can be deployed across two different regions but may support partnering between the regions such that at least one particular regions may be configured with an RCOI of the other region in order to provide emergency calling services for wireless devices of the other region that may be present within the particular region (and being configured with RCOIs for both regions).

As shown in FIG. 2B, a region 201-1B may include the USA and a region 201-2B may include the UK. Region 201-1B can include an ANP subsystem 210-1B including a radio node 212-1B (a WLAN AP) and an emergency services IDP subsystem 230-1B. Region 201-2B can include an ANP subsystem 210-2B including a radio node 212-2B (a WLAN AP) and an emergency services IDP subsystem 230-2B.

A wireless device 202-1B is also shown within region 201-1B and a wireless device 202-2B is also shown within region 201-1B.

For the example of FIG. 2B, corresponding wireless devices 202-1B and 202-2B can be configured with corresponding emergency calling network identifiers to support access in one regime/region. ANP subsystem 210-2B within region 201-2B can be configured with a corresponding emergency calling network identifier to support access in one regime/region, yet ANP subsystem 210-1B within region 201-1B can be configured to provide emergency calling support for both region 201-1B and region 201-2B through the partnering agreement and therefore can be configured with multiple emergency calling network identifiers (RCOIs)-one RCOI for region 201-1B and another RCOI for region 201-2B.

As illustrated in FIG. 2B, wireless device 202-1B can be configured with the RCOI “D1-6C-B4-34-80” for its emergency calling network identifier 204-1B and radio node 212-1B can be configured with the RCOI “D1-6C-B4-34-80” for region 201-1B and also can be configured with the RCOI “D1-6C-B4-33-A0” for region 201-2B for its emergency calling network identifiers 216-1B.

Wireless device 202-2B can be configured with the RCOI “D1-6C-B4-33-A0” for its emergency calling network identifier 204-2B. Radio node 212-2B can be configured with the RCOI “D1-6C-B4-33-A0” for its emergency calling network identifier 216-2B to provide emergency calling services within region 201-2B.

For the example of FIG. 2B, ANP subsystem 210-1B and radio node 212-1B can support emergency calling services both for wireless device 202-1B and for wireless device 202-2B. Thus, in accordance with embodiments herein, a wireless network in one regime can be configured to support emergency calling services for multiple regimes. In some embodiments, an order of multiple emergency calling network identifiers that may be configured for a given wireless network may indicate a preference for providing emergency calling services for a primary regime/region but also supporting emergency calling services for one or more secondary regimes/regions.

Although not shown in FIG. 2B, in some embodiments a wireless device can also be configured with emergency calling network identifiers for multiple regimes. For example, wireless device 202-1B could be configured with RCOI “D1-6C-B4-34-80” and with RCOI “D1-6C-B4-33-A0” for its emergency calling network identifiers such that the wireless device 202-1B could perform emergency calling both in the USA and in the UK.

In some embodiments, an order of multiple emergency calling network identifiers provided for a wireless device can be used to indicate a preference for selecting a particular access network (e.g., corresponding to the highest-ranking emergency calling network identifier in the list) with which to initiate an emergency call.

Moving to FIG. 2C, FIG. 2C includes a system 200C illustrating an example in which regional emergency services IDP subsystems can be deployed across two different regions in which the ANP subsystems can support global roaming such that a global regime or global region can be supported via the ANP subsystems.

As shown in FIG. 2C, a region 201-1C may include the USA and a region 201-2C may include the UK. Region 201-1C can include an ANP subsystem 210-1C including a radio node 212-1C (a WLAN AP) and an emergency services IDP subsystem 230-1C. Region 201-2C can include an ANP subsystem 210-2C including a radio node 212-2C (a WLAN AP) and an emergency services IDP subsystem 230-2C.

A wireless device 202-1C is also shown within region 201-1C and a wireless device 202-3C is also shown within region 201-1C. A wireless device 202-2C is also shown within region 201-2C.

For the example of FIG. 2C, ANP subsystem 210-1C within region 201-1C can be configured with emergency calling network identifiers 216-1C (RCOIs) for both region 201-1C (RCOI “D1-6C-B4-34-80”) and for a global regime/global region, which can be indicated using an RCOI “ D1-6C-B4-FF-F0” in which the second sub-identifier of the RCOI can be set to a value that is predefined to correspond to a global regime/region that can be used to indicate support for any/all regimes/regions that may provide emergency calling services. An emergency calling network identifier that is configured for a global regime/region can be referred to herein as a global emergency calling network identifier such that the global emergency calling network identifier can be associated with a global region that includes all regions that are to support emergency calling.

Providing support for such a global regime/global region may be useful for scenarios in which an ANP may desire to support emergency calling services for any wireless devices that may be present within their region but for which the particular home network of such wireless devices (and the particular RCOI of the device's home network) may not be known/configured within the ANP subsystem of the ANP. Thus, an ANP may want to allow emergency access to any device regardless of the home region or the provisioned RCOI on the device. Further, an ANP may not have knowledge of and/or be configured with all region-specific RCOIs.

ANP subsystem 210-2C and radio node 212-2C can also be configured with emergency calling network identifiers 216-2C (RCOIs) for both region 201-2C, RCOI “D1-6C-B4-33-A0”, and for the global regime/global region, RCOI “D1-6C-B4-FF-F0” (e.g., a global emergency calling network identifier).

As illustrated in FIG. 2B, wireless device 202-1C can be configured with the RCOI “D1-6C-B4-34-80” and with RCOI “D1-6C-B4-FF-F0” for its emergency calling network identifiers 204-1C and wireless device 202-2C can be configured with RCOI “ D1-6C-B4-33-A0” for its emergency calling network identifier 204-2C.

Regarding wireless device 202-3C, wireless device can be configured with an RCOI “D1-6C-B4-0A-20” in which the second sub-identifier “0A-2X” can correspond to Christmas Island (integer country code 162, hexadecimal “0A2”) and can be configured with the global regime/global region RCOI of “D1-6C-B4-FF-F0” for its emergency calling network identifiers 204-3C.

Thus, as illustrated in FIG. 2C, a wireless device may be configured to support access in all of regimes, but with preference or priority for its home regime. For example, RCOIs=[D1-6C-B4-34-80, D1-6C-B4-FF-F0] configured for wireless device 202-1C indicating a preference for RCOI: “D1-6C-B4-34-80” (assuming the first RCOI in the list is the highest preference/priority RCOI) for emergency service network selection and RCOIs=[D1-6C-B4-0A-20, D1-6C-B4-FF-F0] for wireless device 202-3C indicating a preference for RCOI: “D1-6C-B4-0A-20” for emergency service network selection. However, because each of wireless device 202-1C and wireless device 202-3C are also configured with the global emergency calling network identifier, each wireless device could still connect to a given ANP subsystem/radio node that supports/is configured with the global emergency calling network identifier for an emergency call even if their preferred RCOI is not matched.

Similarly, an access network, such as ANP subsystem 210-1C/radio node 212-1C and ANP subsystem 210-2C/radio node 212-2C, can be configured with identifiers corresponding to the regulatory regimes supported including being configured to support access in all regimes, but each with a preference for its home regime, e.g., configured RCOIs=[D1-6C-B4-34-80, D1-6C-B4-FF-F0] for radio node 212-1C and configured RCOIs [D1-6C-B4-3A-A0, D1-6C-B4-FF-F0] for radio node 212-2C.

In at least one embodiment, such as for a PLMN-ID use case, an MNC can be set to 901 to indicate a global regime/global region.

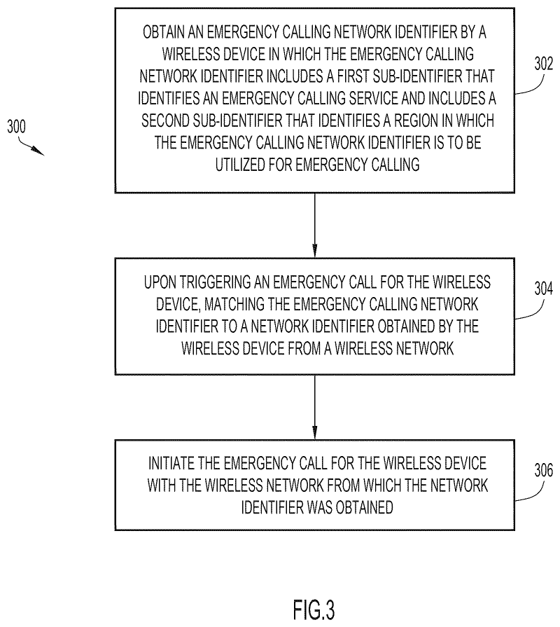

Referring to FIG. 3, FIG. 3 is a flowchart depicting a method 300 according to an example embodiment. In at least one embodiment, operations for method 300 may be performed, at least in part, by a wireless device, such as any wireless device as discussed herein.

At 302, the method may include obtaining an emergency calling network identifier by a wireless device (e.g., a device-identifier as referred to herein) in which the emergency calling network identifier includes a first sub-identifier that identifies an emergency calling service and includes a second sub-identifier that identifies a region in which the emergency calling network identifier is to be utilized for emergency calling.

At 304, the method may include, upon triggering an emergency call for the wireless device, matching the emergency calling network identifier to a network identifier obtained by the wireless device from a wireless network (e.g., an access-identifier as referred to herein). In at least one embodiment, the emergency call for the wireless device can be triggered based on a user input provided via an emergency calling app or emergency calling function provided by the OS of the wireless device.

At 306, the method may include initiating the emergency call for the wireless device with the wireless network from which the network identifier was obtained.

In at least one instance, the wireless network can be a WLAN and the emergency calling network identifier can be an RCOI in which the first sub-identifier is encoded in 24-bits of the RCOI, and the second sub-identifier is encoded in 12-bits of the RCOI. In at least one instance, the wireless network can be a wireless wide area network (WWAN) and the emergency calling network identifier can be a Public Land Mobile Network Identifier (PLMN-ID) in which the first sub-identifier is encoded in a Mobile Country Code (MCC) of the PLMN-ID and the second sub-identifier is encoded in a Mobile Network Code (MNC) of the PLMN-ID.

In at least one instance, providing the emergency calling network identifier for the wireless device includes providing a first emergency calling network identifier for the wireless device that is an RCOI in which the first sub-identifier is encoded in 24-bits of the RCOI and the second sub-identifier is encoded in 12-bits of the RCOI and providing a second emergency calling network identifier for the wireless device that is a PLMN-ID in which the first sub-identifier is encoded in a Mobile Country Code (MCC) of the PLMN-ID and the second sub-identifier is encoded in a Mobile Network Code (MNC) of the PLMN-ID.

In at least one instance, providing the emergency calling network identifier for the wireless device includes providing a global emergency calling network identifier for the wireless device in which the global emergency calling network identifier is associated with a global region that includes all regions that are to support emergency calling.

In at least one instance, providing the emergency calling network identifier for the wireless device includes providing a plurality of emergency calling network identifiers for the wireless device in which each emergency calling network identifier of the plurality of emergency calling network identifiers is associated with a different region. In at least one instance, an order of the plurality of emergency calling network identifiers indicates a preference for initiating the emergency call with a particular wireless network from which a particular network identifier is obtained and that matches a highest ranked emergency calling network identifier of the plurality of emergency calling network identifiers.

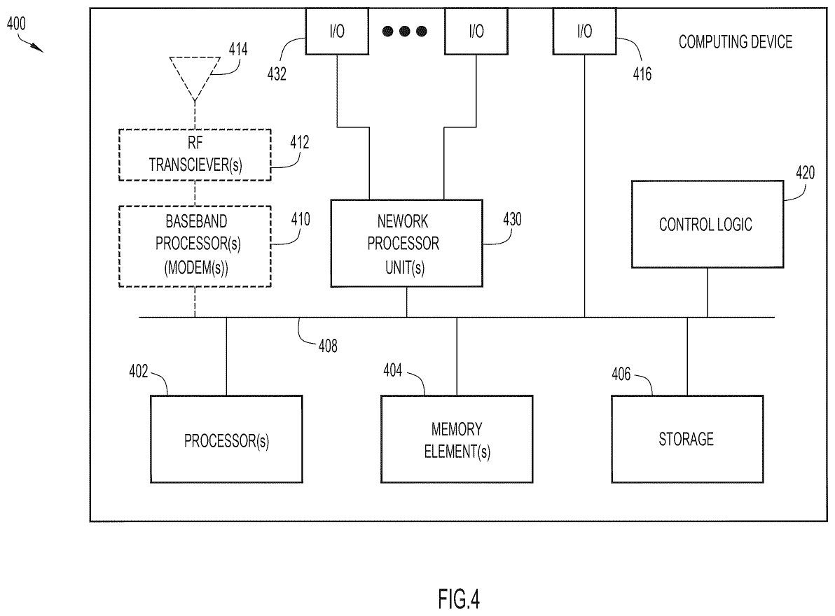

Referring to FIG. 4, FIG. 4 illustrates a hardware block diagram of a computing device 400 that may perform functions associated with operations discussed herein in connection with the techniques described for embodiments herein. In various embodiments, a computing device or apparatus, such as computing device 400 or any combination of computing devices 400, may be configured as any entity/entities in order to perform operations of the various techniques discussed for embodiments herein, such as any elements, functions, etc. discussed for embodiments herein (e.g., any wireless device discussed herein, and ANP subsystem/radio node discussed herein, and any other elements, subsystems, functions, nodes, etc. discussed herein).

In at least one embodiment, the computing device 400 may be any apparatus that may include one or more processor(s) 402, one or more memory element(s) 404, storage 406, a bus 408, one or more network processor unit(s) 430 interconnected with one or more network input/output (I/O) interface(s) 432, one or more I/O interface(s) 416, and control logic 420. In various embodiments, instructions associated with logic for computing device 400 can overlap in any manner and are not limited to the specific allocation of instructions and/or operations described herein.

In some embodiments, computing device 400 may further include at least one baseband processor or modem 410, one or more radio RF transceiver(s) 412 (e.g., any combination of RF receiver(s) and RF transmitter(s)), one or more antenna(s) or antenna array(s) 414 (which may be inclusive of software-defined antenna(s) or antenna array(s).

In at least one embodiment, processor(s) 402 is/are at least one hardware processor configured to execute various tasks, operations and/or functions for computing device 400 as described herein according to software and/or instructions configured for computing device 400. Processor(s) 402 (e.g., a hardware processor, such as a Central Processing Unit (CPU)) can execute any type of instructions associated with data to achieve the operations detailed herein. In one example, processor(s) 402 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 404 and/or storage 406 is/are configured to store data, information, software, and/or instructions associated with computing device 400, and/or logic configured for memory element(s) 404 and/or storage 406. For example, any logic described herein (e.g., control logic 420) can, in various embodiments, be stored for computing device 400 using any combination of memory element(s) 404 and/or storage 406. Note that in some embodiments, storage 406 can be consolidated with memory element(s) 404 (or vice versa) or can overlap/exist in any other suitable manner.

In at least one embodiment, bus 408 can be configured as an interface that enables one or more elements of computing device 400 to communicate in order to exchange information and/or data. Bus 408 can be implemented with any architecture designed for passing control, data and/or information between processors, memory elements/storage, peripheral devices, and/or any other hardware and/or software components that may be configured for computing device 400. In at least one embodiment, bus 408 may be implemented as a fast kernel-hosted interconnect, potentially using shared memory between processes (e.g., logic), which can enable efficient communication paths between the processes.

In various embodiments, network processor unit(s) 430 may enable communication between computing device 400 and other systems, entities, etc., via network I/O interface(s) 432 (wired and/or wireless) to facilitate operations discussed for various embodiments described herein. In various embodiments, network processor unit(s) 430 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 400 and other systems, entities, etc. to facilitate operations for various embodiments described herein. In various embodiments, network I/O interface(s) 432 can be configured as one or more Ethernet port(s), Fibre Channel ports, any other I/O port(s), and/or antenna(s)/antenna array(s) now known or hereafter developed. Thus, the network processor unit(s) 430 and/or network I/O interface(s) 432 may include suitable interfaces for receiving, transmitting, and/or otherwise communicating data and/or information (wired and/or wirelessly) in a network environment.

I/O interface(s) 416 allow for input and output of data and/or information with other entities that may be connected to computing device 400. For example, I/O interface(s) 416 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

If implemented, the RF transceiver(s) 412 may perform RF transmission and RF reception of wireless signals via antenna(s)/antenna array(s) 414, and the baseband processor or modem 410 performs baseband modulation and demodulation, etc. associated with such signals to enable wireless communications for computing device 400.

In various embodiments, control logic 420 can include instructions that, when executed, cause processor(s) 402 and/or network processor unit(s) 430 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 420) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 404 and/or storage 406 can store data, software, code, instructions (e.g., processor instructions), logic, parameters, combinations thereof, and/or the like used for operations described herein. This includes memory element(s) 404 and/or storage 406 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In one form, a computer-implemented method is provided that may include a method as shown and described herein. In one form an apparatus as shown and described herein is provided. In one form, a system as shown and described herein is provided. In one form, one or more computer readable storage media encoded with software comprising computer executable instructions is/are provided herein that, when the software, is/are executed operable to perform operations as shown and described herein.

In some aspects, the techniques described herein relate to a method including: obtaining an emergency calling network identifier by a wireless device, wherein the emergency calling network identifier includes a first sub-identifier that identifies an emergency calling service and includes a second sub-identifier that identifies a region in which the emergency calling network identifier is to be utilized for emergency calling; upon triggering an emergency call for the wireless device, matching the emergency calling network identifier to a network identifier obtained by the wireless device from a wireless network; and initiating the emergency call for the wireless device with the wireless network from which the network identifier was obtained.

In some aspects, the techniques described herein relate to a method, wherein the wireless network is a wireless local area network (WLAN) and the emergency calling network identifier is a Roaming Consortium Organizational Identifier (RCOI) in which the first sub-identifier is encoded in 24-bits of the RCOI and the second sub-identifier is encoded in 12-bits of the RCOI.

In some aspects, the techniques described herein relate to a method, wherein the wireless network is a wireless wide area network (WWAN) and the emergency calling network identifier is a Public Land Mobile Network Identifier (PLMN-ID) in which the first sub-identifier is encoded in a Mobile Country Code (MCC) of the PLMN-ID and the second sub-identifier is encoded in a Mobile Network Code (MNC) of the PLMN-ID.

In some aspects, the techniques described herein relate to a method, wherein obtaining the emergency calling network identifier by the wireless device includes: obtaining a first emergency calling network identifier for the wireless device that is a Roaming Consortium Organizational Identifier (RCOI) in which the first sub-identifier is encoded in 24-bits of the RCOI and the second sub-identifier is encoded in 12-bits of the RCOI; and obtaining a second emergency calling network identifier for the wireless device that is a Public Land Mobile Network Identifier (PLMN-ID) in which the first sub-identifier is encoded in a Mobile Country Code (MCC) of the PLMN-ID and the second sub-identifier is encoded in a Mobile Network Code (MNC) of the PLMN-ID.

In some aspects, the techniques described herein relate to a method, wherein obtaining the emergency calling network identifier by the wireless device includes obtaining a global emergency calling network identifier for the wireless device in which the global emergency calling network identifier is associated with a global region that includes all regions that are to support emergency calling.

In some aspects, the techniques described herein relate to a method, wherein obtaining the emergency calling network identifier obtaining the wireless device includes obtaining a plurality of emergency calling network identifiers for the wireless device in which each emergency calling network identifier of the plurality of emergency calling network identifiers is associated with a different region.

In some aspects, the techniques described herein relate to a method, wherein an order of the plurality of emergency calling network identifiers indicates a preference for initiating the emergency call with a particular wireless network from which a particular network identifier is obtained and that matches a highest ranked emergency calling network identifier of the plurality of emergency calling network identifiers.

In some aspects, the techniques described herein relate to a method, wherein the emergency calling network identifier is obtained by the wireless device via a public warning system broadcast.

In some aspects, the techniques described herein relate to a method, wherein the emergency calling network identifier is obtained by the wireless device via at least one of: a network service provider; or an equipment manufacturer or vendor of the wireless device.

In some aspects, the techniques described herein relate to one or more non-transitory computer readable storage media encoded with instructions that, when executed by a processor, cause the processor to perform operations, including: obtaining an emergency calling network identifier by a wireless device, wherein the emergency calling network identifier includes a first sub-identifier that identifies an emergency calling service and includes a second sub-identifier that identifies a region in which the emergency calling network identifier is to be utilized for emergency calling; upon triggering an emergency call for the wireless device, matching the emergency calling network identifier to a network identifier obtained by the wireless device from a wireless network; and initiating the emergency call for the wireless device with the wireless network from which the network identifier was obtained.

In some aspects, the techniques described herein relate to a media, wherein the wireless network is a wireless local area network (WLAN) and the emergency calling network identifier is a Roaming Consortium Organizational Identifier (RCOI) in which the first sub-identifier is encoded in 24-bits of the RCOI and the second sub-identifier is encoded in 12-bits of the RCOI.

In some aspects, the techniques described herein relate to a media, wherein the wireless network is a wireless wide area network (WWAN) and the emergency calling network identifier is a Public Land Mobile Network Identifier (PLMN-ID) in which the first sub-identifier is encoded in a Mobile Country Code (MCC) of the PLMN-ID and the second sub-identifier is encoded in a Mobile Network Code (MNC) of the PLMN-ID.

In some aspects, the techniques described herein relate to a media, wherein obtaining the emergency calling network identifier by the wireless device includes: obtaining a first emergency calling network identifier for the wireless device that is a Roaming Consortium Organizational Identifier (RCOI) in which the first sub-identifier is encoded in 24-bits of the RCOI and the second sub-identifier is encoded in 12-bits of the RCOI; and obtaining a second emergency calling network identifier for the wireless device that is a Public Land Mobile Network Identifier (PLMN-ID) in which the first sub-identifier is encoded in a Mobile Country Code (MCC) of the PLMN-ID and the second sub-identifier is encoded in a Mobile Network Code (MNC) of the PLMN-ID.

In some aspects, the techniques described herein relate to a media, wherein obtaining the emergency calling network identifier for the wireless device includes obtaining a global emergency calling network identifier for the wireless device in which the global emergency calling network identifier is associated with a global region that includes all regions that are to support emergency calling.

In some aspects, the techniques described herein relate to a media, wherein obtaining the emergency calling network identifier for the wireless device includes obtaining a plurality of emergency calling network identifiers for the wireless device in which each emergency calling network identifier of the plurality of emergency calling network identifiers is associated with a different region.

In some aspects, the techniques described herein relate to a media, wherein an order of the plurality of emergency calling network identifiers indicates a preference for initiating the emergency call with a particular wireless network from which a particular network identifier is obtained and that matches a highest ranked emergency calling network identifier of the plurality of emergency calling network identifiers.

In some aspects, the techniques described herein relate to a wireless device including: at least one memory element for storing data; and at least one processor for executing instructions associated with the data, wherein executing the instructions causes the wireless to perform operations, including: obtaining an emergency calling network identifier, wherein the emergency calling network identifier includes a first sub-identifier that identifies an emergency calling service and includes a second sub-identifier that identifies a region in which the emergency calling network identifier is to be utilized for emergency calling; upon triggering an emergency call, matching the emergency calling network identifier to a network identifier obtained by the wireless device from a wireless network; and initiating the emergency call with the wireless network from which the network identifier was obtained.

In some aspects, the techniques described herein relate to a wireless device, wherein the wireless network is a wireless local area network (WLAN) and the emergency calling network identifier is a Roaming Consortium Organizational Identifier (RCOI) in which the first sub-identifier is encoded in 24-bits of the RCOI and the second sub-identifier is encoded in 12-bits of the RCOI.

In some aspects, the techniques described herein relate to a wireless device, wherein the wireless network is a wireless wide area network (WWAN) and the emergency calling network identifier is a Public Land Mobile Network Identifier (PLMN-ID) in which the first sub-identifier is encoded in a Mobile Country Code (MCC) of the PLMN-ID and the second sub-identifier is encoded in a Mobile Network Code (MNC) of the PLMN-ID.

In some aspects, the techniques described herein relate to a wireless device, wherein obtaining the emergency calling network identifier for the wireless device includes obtaining a global emergency calling network identifier for the wireless device in which the global emergency calling network identifier is associated with a global region that includes all regions that are to support emergency calling.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi 7®), IEEE 802.16 (e.g., Worldwide Interoperability for Microwave Access (WiMAX)), Radio-Frequency Identification (RFID), Near Field Communication (NFC), Bluetooth™, mm. wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and, in the claims, can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, service, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
obtaining an emergency calling network identifier by a wireless device, wherein the emergency calling network identifier includes a first sub-identifier that identifies an emergency calling service and includes a second sub-identifier that identifies a region in which the emergency calling network identifier is to be utilized for emergency calling;
upon triggering an emergency call for the wireless device, matching the emergency calling network identifier to a network identifier obtained by the wireless device from a wireless network; and
initiating the emergency call for the wireless device with the wireless network from which the network identifier was obtained.

2. The method of claim 1, wherein the wireless network is a wireless local area network (WLAN) and the emergency calling network identifier is a Roaming Consortium Organizational Identifier (RCOI) in which the first sub-identifier is encoded in 24-bits of the RCOI and the second sub-identifier is encoded in 12-bits of the RCOI.

3. The method of claim 1, wherein the wireless network is a wireless wide area network (WWAN) and the emergency calling network identifier is a Public Land Mobile Network Identifier (PLMN-ID) in which the first sub-identifier is encoded in a Mobile Country Code (MCC) of the PLMN-ID and the second sub-identifier is encoded in a Mobile Network Code (MNC) of the PLMN-ID.

4. The method of claim 1, wherein obtaining the emergency calling network identifier by the wireless device includes:
obtaining a first emergency calling network identifier for the wireless device that is a Roaming Consortium Organizational Identifier (RCOI) in which the first sub-identifier is encoded in 24-bits of the RCOI and the second sub-identifier is encoded in 12-bits of the RCOI; and
obtaining a second emergency calling network identifier for the wireless device that is a Public Land Mobile Network Identifier (PLMN-ID) in which the first sub-identifier is encoded in a Mobile Country Code (MCC) of the PLMN-ID and the second sub-identifier is encoded in a Mobile Network Code (MNC) of the PLMN-ID.

5. The method of claim 1, wherein obtaining the emergency calling network identifier by the wireless device includes obtaining a global emergency calling network identifier for the wireless device in which the global emergency calling network identifier is associated with a global region that includes all regions that are to support emergency calling.

6. The method of claim 1, wherein obtaining the emergency calling network identifier obtaining the wireless device includes obtaining a plurality of emergency calling network identifiers for the wireless device in which each emergency calling network identifier of the plurality of emergency calling network identifiers is associated with a different region.

7. The method of claim 6, wherein an order of the plurality of emergency calling network identifiers indicates a preference for initiating the emergency call with a particular wireless network from which a particular network identifier is obtained and that matches a highest ranked emergency calling network identifier of the plurality of emergency calling network identifiers.

8. The method of claim 1, wherein the emergency calling network identifier is obtained by the wireless device via a public warning system broadcast.

9. The method of claim 1, wherein the emergency calling network identifier is obtained by the wireless device via at least one of:
a network service provider; or
an equipment manufacturer or vendor of the wireless device.

10. One or more non-transitory computer readable storage media encoded with instructions that, when executed by a processor, cause the processor to perform operations, comprising:
obtaining an emergency calling network identifier by a wireless device, wherein the emergency calling network identifier includes a first sub-identifier that identifies an emergency calling service and includes a second sub-identifier that identifies a region in which the emergency calling network identifier is to be utilized for emergency calling;
upon triggering an emergency call for the wireless device, matching the emergency calling network identifier to a network identifier obtained by the wireless device from a wireless network; and
initiating the emergency call for the wireless device with the wireless network from which the network identifier was obtained.

11. The media of claim 10, wherein the wireless network is a wireless local area network (WLAN) and the emergency calling network identifier is a Roaming Consortium Organizational Identifier (RCOI) in which the first sub-identifier is encoded in 24-bits of the RCOI and the second sub-identifier is encoded in 12-bits of the RCOI.

12. The media of claim 10, wherein the wireless network is a wireless wide area network (WWAN) and the emergency calling network identifier is a Public Land Mobile Network Identifier (PLMN-ID) in which the first sub-identifier is encoded in a Mobile Country Code (MCC) of the PLMN-ID and the second sub-identifier is encoded in a Mobile Network Code (MNC) of the PLMN-ID.

13. The media of claim 10, wherein obtaining the emergency calling network identifier by the wireless device includes:
obtaining a first emergency calling network identifier for the wireless device that is a Roaming Consortium Organizational Identifier (RCOI) in which the first sub-identifier is encoded in 24-bits of the RCOI and the second sub-identifier is encoded in 12-bits of the RCOI; and
obtaining a second emergency calling network identifier for the wireless device that is a Public Land Mobile Network Identifier (PLMN-ID) in which the first sub-identifier is encoded in a Mobile Country Code (MCC) of the PLMN-ID and the second sub-identifier is encoded in a Mobile Network Code (MNC) of the PLMN-ID.

14. The media of claim 10, wherein obtaining the emergency calling network identifier for the wireless device includes obtaining a global emergency calling network identifier for the wireless device in which the global emergency calling network identifier is associated with a global region that includes all regions that are to support emergency calling.

15. The media of claim 10, wherein obtaining the emergency calling network identifier for the wireless device includes obtaining a plurality of emergency calling network identifiers for the wireless device in which each emergency calling network identifier of the plurality of emergency calling network identifiers is associated with a different region.

16. The media of claim 15, wherein an order of the plurality of emergency calling network identifiers indicates a preference for initiating the emergency call with a particular wireless network from which a particular network identifier is obtained and that matches a highest ranked emergency calling network identifier of the plurality of emergency calling network identifiers.

17. A wireless device comprising:
at least one memory element for storing data; and
at least one processor for executing instructions associated with the data, wherein executing the instructions causes the wireless to perform operations, comprising:
obtaining an emergency calling network identifier, wherein the emergency calling network identifier includes a first sub-identifier that identifies an emergency calling service and includes a second sub-identifier that identifies a region in which the emergency calling network identifier is to be utilized for emergency calling;
upon triggering an emergency call, matching the emergency calling network identifier to a network identifier obtained by the wireless device from a wireless network; and
initiating the emergency call with the wireless network from which the network identifier was obtained.

18. The wireless device of claim 17, wherein the wireless network is a wireless local area network (WLAN) and the emergency calling network identifier is a Roaming Consortium Organizational Identifier (RCOI) in which the first sub-identifier is encoded in 24-bits of the RCOI and the second sub-identifier is encoded in 12-bits of the RCOI.

19. The wireless device of claim 17, wherein the wireless network is a wireless wide area network (WWAN) and the emergency calling network identifier is a Public Land Mobile Network Identifier (PLMN-ID) in which the first sub-identifier is encoded in a Mobile Country Code (MCC) of the PLMN-ID and the second sub-identifier is encoded in a Mobile Network Code (MNC) of the PLMN-ID.

20. The wireless device of claim 17, wherein obtaining the emergency calling network identifier for the wireless device includes obtaining a global emergency calling network identifier for the wireless device in which the global emergency calling network identifier is associated with a global region that includes all regions that are to support emergency calling.
